(19) United States
(12) Patent Application Publication
(10) Pub. No.: US 2017/0143564 A1
(43) Pub. Date: May 25, 2017

(54) MULTI-POSITIONAL SECTION FOR A TREATMENT TABLE

(71) Applicant: Cardon Rehabilitation & Medical Equipment Ltd., Burlington (CA)

(72) Inventors: Mardig SEVADJIAN, Oakville (CA); Robert Howard ROWE, Jacksonville, FL (US)

(21) Appl. No.: 14/949,250

(22) Filed: Nov. 23, 2015

(51) Int. Cl. A61G 7/015

(52) U.S. Cl. CPC A61G 7/015

(57) ABSTRACT

The invention relates generally to a treatment table, and specifically to a sectional treatment table with a bed platform which has at least two sections, and at least one of these bed platform sections is adapted to be multi-positional. In use, the multi-positional section is capable of sliding from side to side relative to the rest of the bed platform. The invention also relates to adapting an existing treatment bed to include a multi-positional section or a multi-positional adjusting mechanism.

### FIELD OF THE INVENTION

The invention relates generally to a treatment table, and specifically to a sectional treatment table which may be adjusted to have multiple positions.

### BACKGROUND OF THE INVENTION

Treatment tables need to accommodate individuals of different size and requiring a variety of treatments for various parts of the body, and to enable the therapists treating the individuals to be able to reach the various parts of the body to be treated. Therapists, in this context, refer to anyone who needs to access an individual on a treatment table, and treatment refers to any contact with an individual with or without machines or aids. Treatment tables have been adapted to comprise sections, such as a head section, fixed or adjustable center section and leg section, in order to adjust the table for the individual being treated as well as improve the accessibility to the individual for the therapist. The head section on a sectional treatment table is generally the smallest section; however, in certain positions of such a table, the so-called “leg” section supports the back and head, the center section supports the thighs and the so-called “head” section supports the calves and possibly also the feet, depending on the size of the individual on the table. Other treatment tables have only one or two sections rather than three, or additionally include side sections capable of being used as arm rests and of being raised or lowered.

There are several types of adjustable treatment tables, for example, as described in U.S. Pat. Nos. 8,672,971 and 7,189,214, there are adjustable treatment tables with three sections in which the head section is smaller than the other two sections. In U.S. Pat. No. 8,374,312 there is described a treatment table with two sections and with modifications specifically to allow a radiation beam to pass through a body portion exposed by an opening in the table.

It is desirable to have an adjustable treatment table which improves accessibility to the individual being treated for a therapist or provides additional options for adjusting the table.

### SUMMARY OF THE INVENTION

In accordance with one aspect of the invention, there is provided a sectional treatment table with at least one section which is multi-positional. In a further embodiment, this multi-positional section is the head section or the leg section of the treatment table. In a further embodiment, this multi-positional section is narrower in width than the other one or more sections. In a further embodiment, this multi-positional section is wider than the other one or more sections.

In accordance with a further aspect of the invention, there is provided a treatment table having a bed platform divided into at least two sections, wherein at least one section is a multi-positional section, said multi-positional section comprising a multi-positional adjustment mechanism to slide the multi-positional section from side to side relative to the other one or more sections.

In accordance with a further aspect of the invention, there is provided a multi-positional adjusting mechanism for adjusting a platform, comprising a rod system and a supporting framework, wherein said rod system comprises an upper rod, a lower rod, an upper tube and a lower tube, said rods are longer than said tubes and said upper rod is slidably engaged within said upper tube and said lower rod is slidably engaged within said lower tube, said supporting framework comprises at least two side bars parallel to each other, each side bar having an upper end and a lower end, wherein the upper end of each side bar is joined to the upper tube and the lower end of each side bar is joined to the lower tube such that the upper tube is parallel to the lower tube.

In accordance with a further aspect of the invention, there is provided a multi-positional section for a sectional treatment table comprising a multi-positional adjusting mechanism and a bed platform with a top surface and a bottom surface, wherein said rods of the multi-position adjusting mechanism are attached to the bottom surface of the bed platform such that said upper rod remains slidably engaged within said upper tube and said lower rod remains slidably engaged within said lower tube.

In accordance with a further aspect of the invention, there is provided a multi-positional adjusting mechanism which additionally comprises a locking system for securing the upper rod in one or more positions within the upper tube when the locking system is in a locked position, and for allowing the upper rod to be slidably engaged within said upper tube when the locking system is disengaged.

In accordance with a further aspect of the invention, there is provided a method of adapting a treatment table comprising a table base and a bed platform divided into at least two bed platform sections wherein each of said bed platform sections comprises a top surface and a bottom surface, said method comprising the steps of attaching a multi-positional adjusting mechanism to the bottom surface of one of said bed platform sections and attaching the supporting framework of the multi-positional adjusting mechanism to said table base.

In accordance with a further aspect of the invention, there is provided a method of adapting a treatment table comprising a table base and a bed platform divided into at least two bed platform sections, said method comprising the steps of removing a bed platform section from the treatment table and replacing said bed platform section with a multi-positional section.

### DESCRIPTION OF THE DRAWINGS

In the drawings which illustrate by way of example only an embodiment of the invention:

FIG. 1 is a top view of a treatment table with three sections, according to an embodiment of the present invention.

FIG. 2 is a bottom view of a multi-positional section of a treatment table, set in a substantially central position, according to an embodiment of the present invention.

FIG. 3 is a bottom view of the multi-positional section of a treatment table, set in a side position, according to an embodiment of the present invention.

FIG. 4 is a perspective view from the bottom of the supporting framework and rod system of a multi-positional section of a treatment table, according to an embodiment of the present invention.

FIG. 5 is a side view of a locking system of a multi-positional section of a treatment table, according to an embodiment of the present invention.

FIG. 6 is a perspective view of a locking system of a multi-positional section of a treatment table, according to an embodiment of the present invention.

### DETAILED DESCRIPTION OF THE DRAWINGS

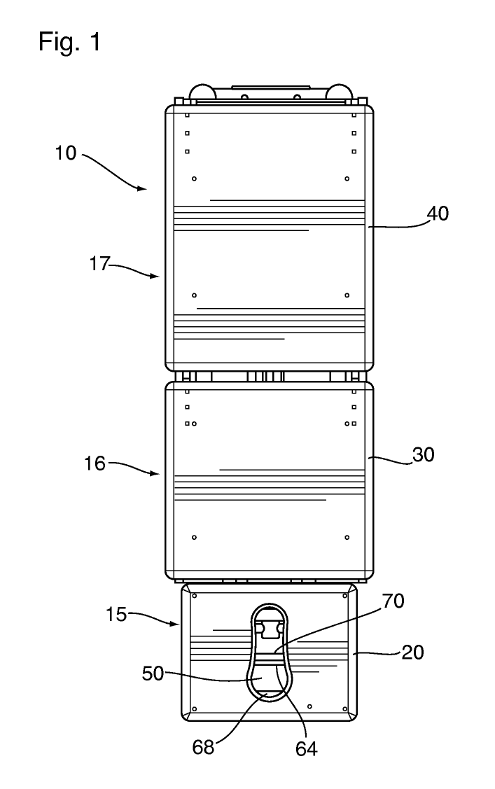

Referring to FIG. 1, a sectional treatment table 10 according to an embodiment of the present invention is shown having three sections, a first section 15, a second section 16 and a third section 17. From this top view of the sections of the treatment table 10, the bed on which an individual may rest is comprised of a first bed platform 20, a second bed platform 30 and a third bed platform 40. In the embodiment shown in FIG. 1, the first section 15 is the multi-positional section for a treatment table of the present invention.

The multi-positional section 15 comprises a multi-positional adjusting mechanism and a bed platform. The multi-positional adjusting mechanism is comprised of at least a supporting framework and a rod system.

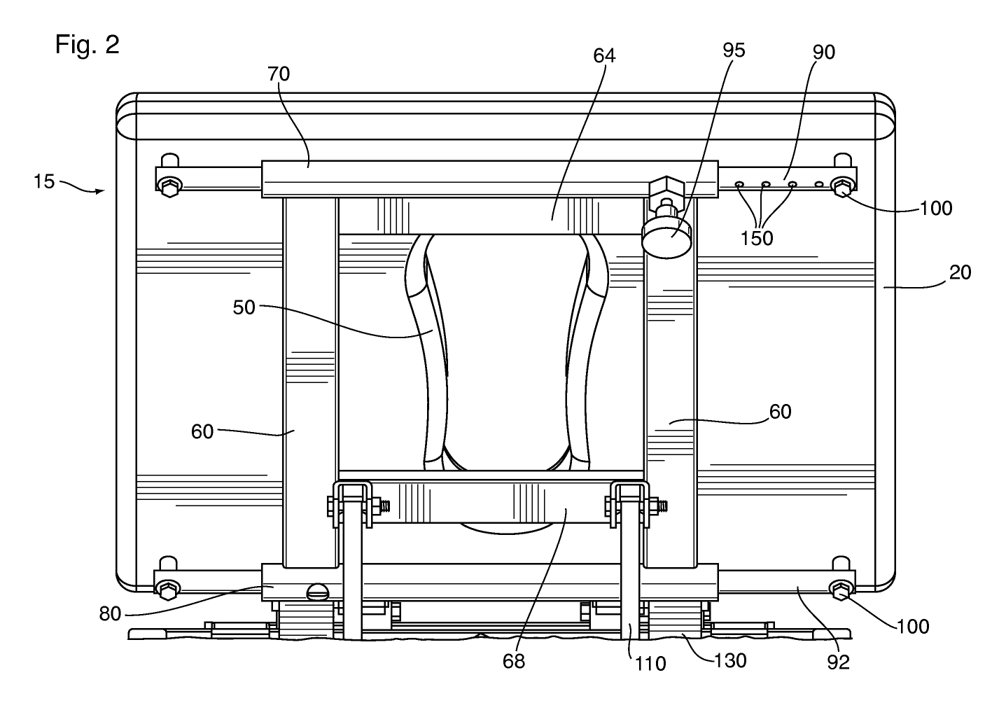

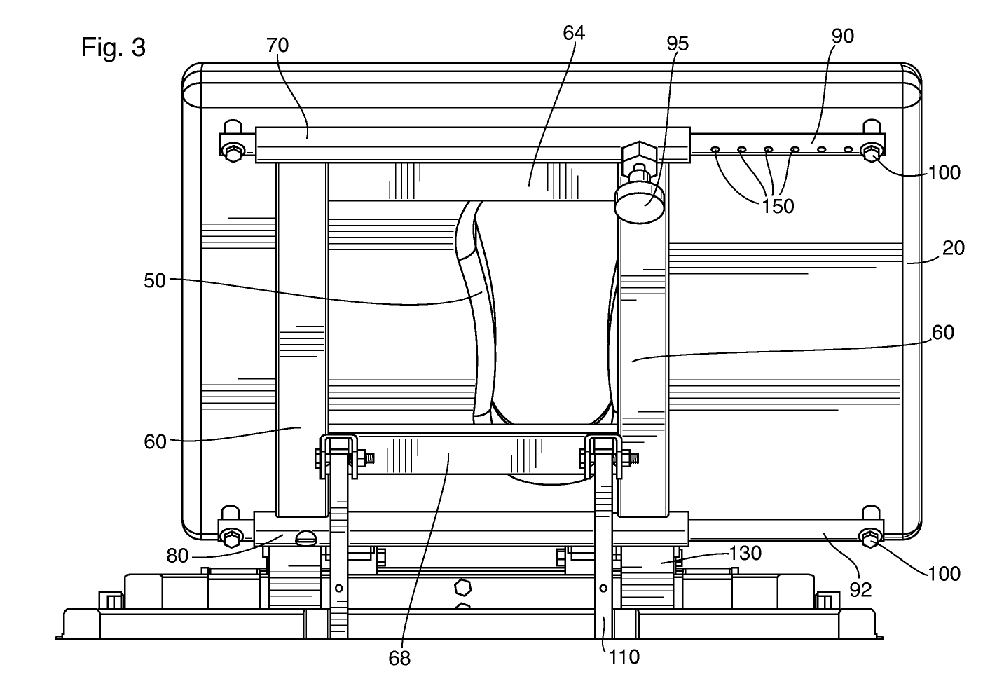

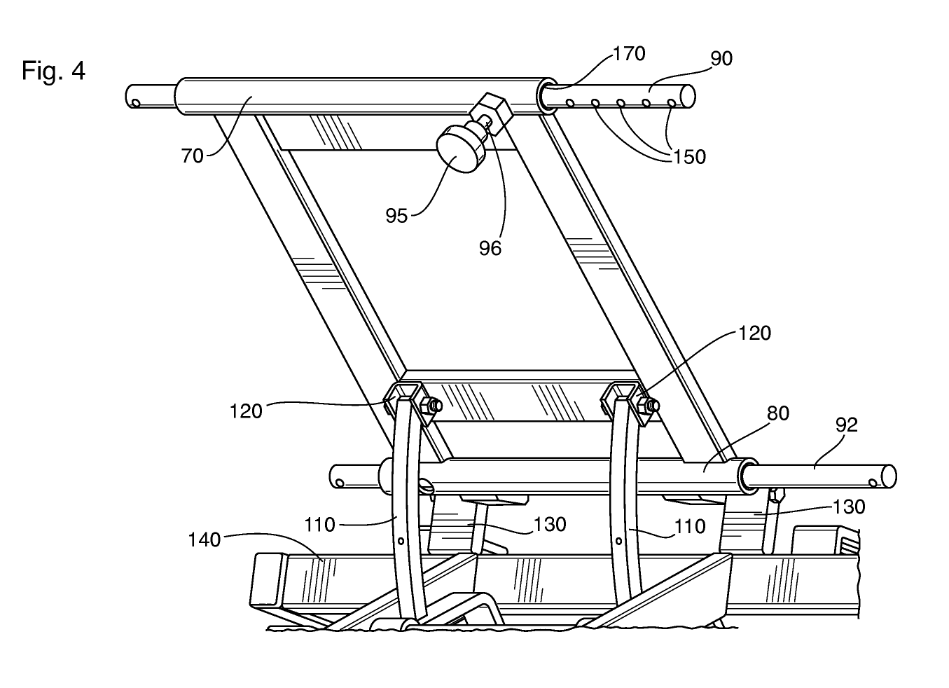

In an embodiment of the present invention as shown in FIG. 2, a multi-positional section 15 for a treatment table is set in a substantially central position. Another position of the multi-positional section 15 is shown in FIG. 3, which is shown set to one side. FIG. 4 shows the multi-positional section with the first bed portion 20 removed. FIGS. 2, 3, and 4 show a supporting framework of the multi-positional section 15 which supporting framework is comprised of frame support uprights 60, upper frame support 64, lower frame support 68. A rod system is also shown which comprises an upper engaging tube 70 and lower engaging tube 80, wherein upper sliding rod 90 and lower sliding rod 92 fit within the upper engaging tube 70 and lower engaging tube 80, respectively. The supporting framework engages with the rod system by attachment of the supporting framework to the upper engaging tube 70 and lower engaging tube 80. Each sliding rod 90, 92 is attached at both ends to the bottom of the first bed portion 20 by sliding rod fastening means 100, although it will be understood that other means of attachment could be used. In this embodiment the supporting framework is attached to the treatment table base through first joining bars 110 attached to lower frame support 68 through frame fastening means 120, and also lower engaging tube 80 is attached to second joining bars 130 which is in turn attached to a table base segment 140.

As seen in FIGS. 2 and 3, the multi-positional section 15 comprises a supporting framework which moves along a rod system. The rod system is connected to the back of the first bed platform 20. Instead of bolting the bed platform to the supporting framework, the bed platform is bolted to the sliding rods, and this allows the first bed platform 20 to move from side to side. In this embodiment of the invention the first bed platform 20 is narrower than the other bed platforms; however, in other embodiments the bed platform could be the same or greater width. For example, a bed platform of the same or greater width could also function as an armrest when someone is laying face-down on the multi-positional section.

The multi-positional adjusting mechanism shown in the figures is comprised of a supporting framework, a rod system and a locking system.

As shown in FIGS. 2, 3, and 4, the supporting framework moves along the rod system, but is capable of locking into place via a locking system of which a knob 95 with a spring loaded pin 96 engages in the holes 150 in sliding rod 90. This locking system is shown in the figures in relation to sliding rod 90 since this puts the knob 95 close to the end of the treatment table 10 and easily reached by a therapist, but this locking system could also be utilized on both sliding rods 90, 92, or with lower sliding rod 92 only.

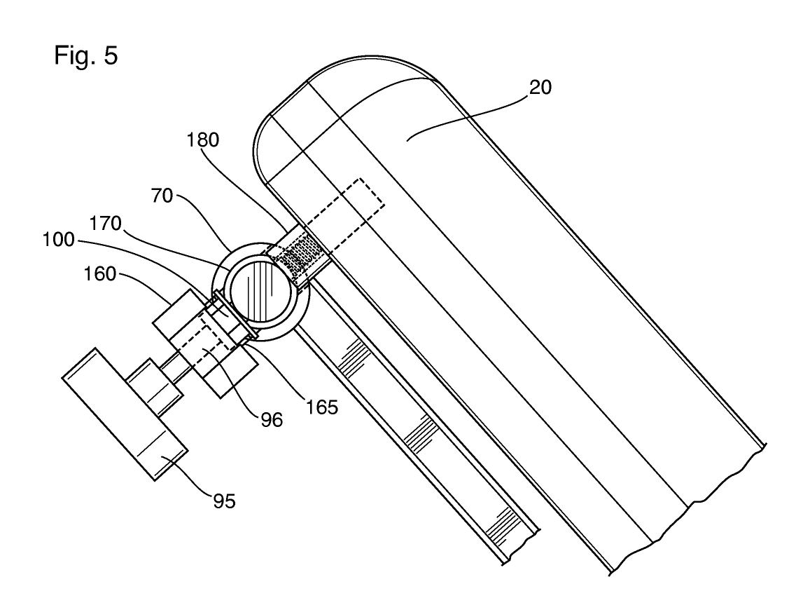

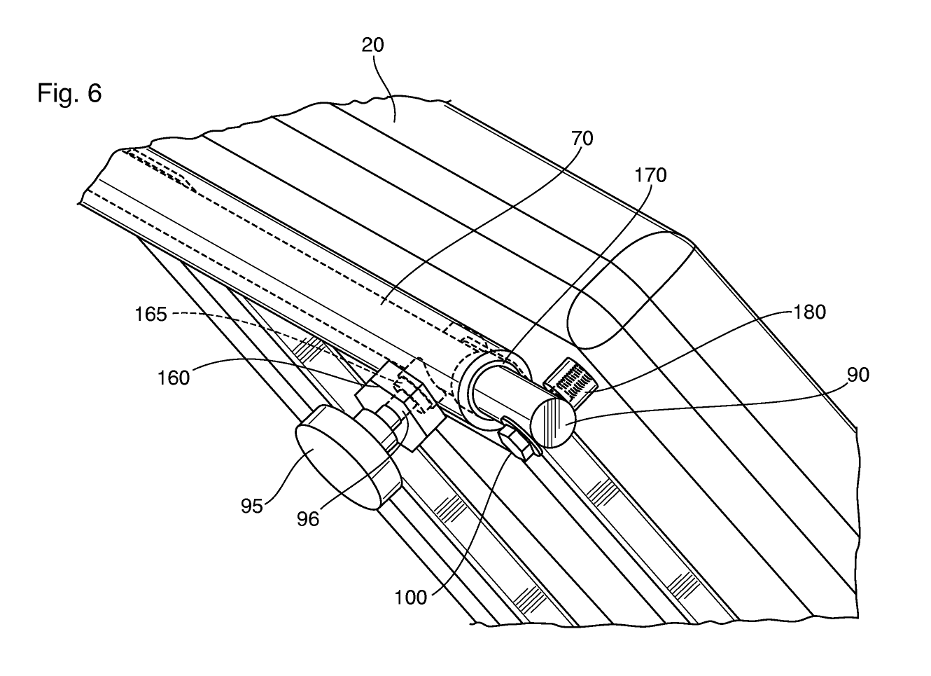

The locking system is shown in more detail in FIGS. 5 and 6 in which knob 95 is used to place a spring loaded pin 96 into one of the holes 150 (shown in the earlier figures) in the upper sliding rod 90. The knob 95 is spaced apart from the upper engaging tube 70 by a positional locking bushing 160 and the spring loaded pin 96 is held in place with a nylon pusher 165.

FIGS. 5 and 6 also show the rod system in more detail, in which a glide bushing 170 is on sliding rods 90 to enable glide, and fastening means 100 includes a spacer 180 which maintains a distance between the sliding rod 90 and first bed portion 20. The glide bushing 170 could be an I-glide and any other embodiment that allows sliding and could be of plastic or bronze or other metal which reduces friction with the sliding rods 90, 92. In a further embodiment of the invention, an existing treatment bed with a bed platform divided into at least two sections could be adapted to include a multi-positional section or a multi-positional adjusting mechanism. This could be accomplished by either removing an existing section of the existing treatment bed and replacing it with the multi-positional section of the present invention, or by attaching the rods of a multi-positional adjusting mechanism of the present invention to the bottom of an existing section of the existing treatment bed, and attaching the supporting framework to the table base.

The embodiment of the invention shown in the figures utilizes a three sectional bed, however this invention can be utilized in a sectional bed with less or more sections, but at least two sections wherein one is the multi-positional section. Further the figures show the use of the invention for the first section 15 which is the “head” section in these figures and may optionally have a key hole slot 50; however the head section is also used as a leg section when an individual is sitting up in such a treatment table and leaning their upper body and head against the third bed platform 40. The multi-positional section could also be used specifically for supporting the legs for podiatry use in another embodiment of the invention, and further could be a width sized for two legs or alternatively for one leg.

The multi-positional section of the treatment table could be the third section 17, in a further embodiment of the invention.

In an embodiment of the present invention, the frame support uprights 60 are about 15 inches long, the upper and lower frame supports 64, 68 are about 12½ inch long and the supporting framework is welded together.

In an embodiment of the rod system, the upper and lower sliding rods 90, 92 are sized ⅝″ and the upper and lower engaging tubes 70, 80 are sized as 1″ outside diameter (o.d.) and ¾″ inside diameter (“i.d.”). It will be apparent to those skilled in the art that variations and modifications can be made to the sizing and other characteristics of the rod system. The rod system could utilize flat bars or square bars or with a bearing shaft.

In an embodiment of the present invention a locking system with a spring loaded pin is described and six holes 150 may be spaced about 1″ apart of ¼″ diameter, plus the holes 150 for the sliding rod fastening means 100 on either end. It will be apparent to those skilled in the art that variations and modifications can be made to the sizing and spacing of the holes and more holes will give more options for setting the position of the multi-positional section and fewer holes will offer fewer options.

It will also be apparent that other means of setting the position of the bed platform are contemplated, for example with a screw or tension system, as well as other spacing for the holes 150. The rod system could also work without setting specific positions for the multi-positional section, and in an embodiment of the invention, in order to avoid shifting of the section, the tubes and rods could be quite snug fitting together while still capable of sliding along. In a further embodiment with a friction pad rather than holes, after sliding to the desired position, tightening a knob causes the friction pad to push tight against the rod and the tube and keep the desired position.

The embodiment of the present invention shown in the figures has two rods and two tubes, although a single rod and tube system could be used with necessary adaptions (as could more than two pairs of rods and tubes).

The embodiment of the present invention described contemplates a bed platform, although it is understood that the multi-positional adjustment mechanism could be used with other platforms and for adapting other systems in which it is desired to move a platform from side to side.

Various embodiments of the present invention having been thus described in detail by way of example, it will be apparent to those skilled in the art that variations and modifications can be made without departing from the invention. The invention includes all such variations and modifications as fall within the scope of the appended claims.

What is claimed is:

1. A treatment table having a bed platform divided into at least two sections, wherein at least one section is a multi-positional section, said multi-positional section comprising a multi-positional adjustment mechanism to slide the multi-positional section from side to side relative to the other one or more sections.

2. The treatment table of claim 1 in which said multi-positional section is narrower in width than the other one or more sections.

3. The treatment table of claim 1 in which said multi-positional section is wider than the other one or more sections.

4. A multi-positional adjusting mechanism for adjusting a platform, comprising a rod system and a supporting framework, wherein said rod system comprises an upper rod, a lower rod, an upper tube and a lower tube, said rods are longer than said tubes and said upper rod is slidably engaged within said upper tube and said lower rod is slidably engaged within said lower tube, said supporting framework comprises at least two side bars parallel to each other, each side bar having an upper end and a lower end, wherein the upper end of each side bar is joined to the upper tube and the lower end of each side bar is joined to the lower tube such that the upper tube is parallel to the lower tube.

5. A multi-positional section for a sectional treatment table comprising the multi-positional adjusting mechanism of claim 4 and a bed platform with a top surface and a bottom surface, wherein said rods of the multi-positional adjusting mechanism are attached to the bottom surface of the bed platform such that said upper rod remains slidably engaged within said upper tube and said lower rod remains slidably engaged within said lower tube.

6. The multi-positional adjusting mechanism of claim 4, additionally comprising a locking system for securing the upper rod in one or more positions within the upper tube when the locking system is in a locked position, and for allowing the upper rod to be slidably engaged within said upper tube when the locking system is disengaged.

7. A method of adapting a treatment table comprising a table base and a bed platform divided into at least two bed platform sections wherein each of said bed platform sections comprises a top surface and a bottom surface, said method comprising the steps of attaching the multi-positional adjusting mechanism of claim 4 to the bottom surface of one of said bed platform sections and attaching the supporting framework of the multi-positional adjusting mechanism to said table base.

8. A method of adapting a treatment table comprising a table base and a bed platform divided into at least two bed platform sections, said method comprising the steps of removing a bed platform section from the treatment table and replacing said bed platform section with the multi-positional section of claim 5.
